(19) United States
(12) Patent Application Publication
(10) Pub. No.: US 2026/0016093 A1
(43) Pub. Date: Jan. 15, 2026

(54) Dosing Orifice

(71) Applicant: Teubert Maschinenbau GmbH, Blumberg (DE)

(72) Inventor: Yannick Teubert, Blumberg (DE)

(21) Appl. No.: 19/267,743

(22) Filed: Jul. 14, 2025

(30) Foreign Application Priority Data
Jul. 15, 2024 (DE) 10 2024 120 171.1

(51) Int. Cl. F16K 3/03; F16K 3/02; G05D 7/06

(52) U.S. Cl. CPC F16K 3/03; F16K 3/0254; G05D 7/0635

(57) ABSTRACT

The present invention relates to a dosing orifice with variable opening width for dosing flowable and/or free-flowing material from a container with a container base having at least two outlets, and wherein the flowable and/or free-flowing material can be removed from the container through these at least two outlets, characterized in that each outlet in the container base can be controlled separately and independently via the dosing orifice.

### BACKGROUND INFORMATION

### Field of the Invention

The invention relates to a container for storing and dispensing flowable and/or free-flowing material with a container base having at least two outlets, whereby the flowable and/or free-flowing material can be removed from the container through these at least two outlets and each outlet in the container base can be controlled separately and independently via a dosing orifice. The invention also relates to the dosing orifice as such.

### Discussion of Prior Art

Dosing orifices have been known in the prior art for some time. The task of dosing orifices is to open or close an opening at the lower end of a container containing free-flowing material. As a rule, the opening cross-section can be adjusted with the aid of an aperture to accommodate different goods. It should be noted that the centre of an aperture opening is not necessarily on the same axis as the centre of a container outlet.

For example, DE 93 09 294 U1 describes a dosing and filling device for pourable food, in which a valve can be operated either manually or by an electromagnet. The valve also has a damping mechanism during the closing process and is held in the open position by a spring. Two mechanisms can be seen from the illustrations and description: a slide valve and a valve that opens by means of a tilting movement. The problem of inaccurate portioning of certain quantities of bulk material is solved by the solution disclosed in DE 93 09 294 U1. The specified quantity is measured in a tray. In the disclosed valve, the centre of the aperture is only at the centre of the container opening when the valve is fully open. The centre of the material flow is at the centre of the valve opening.

In the field of photography, sectional closures have also been known for a long time, which have enabled the exposure of the film. Reference is made here to DD 050 204 A1 and DD 763 678 B3 as examples.

The systems described above relate to the possibility of regulating the material flow, in particular consisting of a free-flowing material, from a single nozzle.

When filling complex moulds with flowable and/or free-flowing material, i.e. bulk material or trickling material, plant operators are also familiar with the practice of fitting a simple dosing device to the opening in the bottom of a container. This dosing device comprises a plate in the bottom of the container, which is provided with a hole pattern, whereby the hole pattern is arranged in such a way that the mould is filled as evenly as possible. This plate and a counterplate, which is also provided with a hole pattern, are rotated against each other to allow the material to flow through the hole pattern and to regulate the amount of material accordingly. The so-called dosing disc, usually made of brass, is set into rotary vibrations by a central motor in order to achieve an outlet flow from the container into a mould. At the actual bottom of the container there are connection options for injectors or further material transport. Different flow rates can be set via different hole patterns and the number of holes in the dosing disc. The material flow is conveyed in pulses by switching the motor on and off.

Controlling individual nozzles, outlets or openings in the hole pattern is not possible with state-of-the-art technology for free-flowing materials, and the quality of the mould filling therefore depends on the (technically) possible hole pattern in the metering disc. Filling complex moulds with complex geometries requires a great deal of experience in producing a suitable hole pattern, a lot of time during the filling process and, if necessary, an increased demand for compressed air. Even small changes in the geometry of the product to be manufactured, which lead to a change in the mould, therefore inevitably lead to a complete replacement of the perforated discs and thus also to a decrease in economic efficiency.

There is therefore a need for a device with which free-flowing material can be removed from a container with several outlets, each of which can be controlled individually and specifically.

### BRIEF SUMMARY OF THE INVENTION

The invention is therefore based on the task of providing a novel dosing orifice with precise control for a container with at least two outlets in order to optimise the filling level of the mould and the material flow and to be able to react quickly to changed requirements during mould filling.

This task is initially solved by a dosing orifice with variable opening width for dosing flowable and/or free-flowing material, comprising
an opening (16) for the flowable and/or free-flowing material, wherein the opening (16) is designed for connection to an outlet of a container, in particular the container described above according to the invention,
a shutter aperture (6) for opening and closing the opening (16) for the flowable and/or free-flowing material,
an electric drive and actuator motor (1) for the shutter aperture (6), wherein the geometric centre of the shutter aperture (6) lies on the axis of the opening (16) for the flowable and/or free-flowing material.

The aforementioned task is preferably solved by independently controllable dosing orifices at the bottom of the container, each of which has a shutter aperture (6) for opening and closing an outlet on the container for flowable and/or free-flowing material, as well as an electric drive and actuator motor (1) for each shutter aperture (6).

A shutter aperture (6) can be designed such that the centre point of the shutter aperture (6) lies on the same axis as the centre point of the respective opening in the container base (‘case 1’), or such that these centre points do not lie on the same axis (‘case 2’).

In the claimed embodiment, case 1, a mechanism with at least two elements is conceivable which, when coupled together, are moved inwards from the edge of the closure aperture via a mechanism in order to close the shutter aperture (6). Due to the coupling of the elements, the centre of the aperture always lies on the centre of the container opening, provided that these are mounted in alignment with each other. Since at least two elements of a shutter aperture (6) are moved in front of the opening in the container base, the surface force exerted by the weight of the bulk material per element is lower than if there were only one element, and the bearings can be dimensioned accordingly to absorb these forces. Despite the necessary mechanics for the shutter aperture (6), this embodiment can therefore be economical.

If, on the other hand, the opening in the container base is closed with an n-sided plate or round disc mounted so that it can rotate tangentially to the opening in the container base (or connected to it by a separate structure) as a shutter aperture (6) in such a way that these elements are rotated in front of the opening at the container base, the centres of the shutter aperture (6) (and thus of the cross-section available to the material flow) and the opening in the container base are not on the same axis (‘case 2’). The same applies to a plate of any shape but of a corresponding size for closing the container opening, which is pushed in front of the opening from the side. The plate is pushed to the centre of the cover opening. This solution also means that if there are several openings in the container base and thus several shutter aperture (6), there could be a space problem, as when the shutter aperture (6) is open, the cover elements must be arranged in such a way that no opening in the container base is blocked.

In a particularly preferred embodiment, in which the centre point of the container opening and the centre point of the shutter aperture (6) lie on one axis, as referred to above as ‘Case 1’, the shutter aperture (6) is a segmented shutter aperture (6) and comprises a transmission unit, which is mechanically connected to the segmented shutter aperture (6) and the electric drive and actuator motor (1), as well as a housing (11, 12).

The opening mechanism of the segmented shutter aperture (6) according to the invention is electrically controlled. The output shaft (2) of an electric drive and actuator motor (1) is set in rotary motion, which is converted into translational motion via a transmission unit. The transmission unit is a gear mechanism for transmitting the motion of the drive and actuator motor (1), which acts at a single point, to the individual aperture segments (6a, 6b, 6c, . . . ) of the shutter aperture (6) with which there is an effective connection. By controlling the individual aperture segments (6a, 6b, 6c, . . . ), the opening ratio of the segmented shutter aperture (6) can be varied.

A housing (11, 12) protects the technical unit, in particular the closing and opening mechanism of the segmented shutter aperture (6) and the free-flowing material, from external influences.

In a preferred embodiment, the electric drive and actuator motor (1) is designed as a servo motor. This allows the exact position of the output shaft (2) and the speed to be controlled. Furthermore, it has proven advantageous to control the motor in a pulsating manner and to provide for a reversal of the direction of rotation so that the shutter aperture (6) opens or closes permanently.

Another preferred embodiment is the choice of a stepper motor, which has considerable cost advantages over the servo motor.

In a special embodiment, a drive pinion (3) is attached to the output shaft (2) of the electric drive and actuator motor (1), which can be moved in two directions of rotation. This enables the rotational movement to be transmitted to the aperture mechanism. A first direction of rotation causes the segmented shutter aperture (6) according to the invention to open, whereas the reverse direction of rotation induces the shutter aperture (6) to close, with the force from the rotational movement acting on the aperture mechanism, which is described in detail below.

The above drive pinion (3) is necessary at least to control the shutter aperture (6) in principle. However, it has proven particularly advantageous to combine the above drive pinion (3) with at least one additional transmission pinion (4) to form the transmission unit together. An additional transmission pinion (4) in addition to the drive pinion (3) provides a more even power transmission to the aperture segments (6a, 6b, 6c, . . . ).

It has proven to be particularly advantageous when the drive pinion (3) is arranged so that it engages with a ring gear (5) with internal teeth surrounding the transmission unit, thereby setting it in rotation. Additional transmission pinions (4) can also be driven by the outer ring, resulting in synchronous movement of all pinions involved. This results in even force distribution to each aperture segment (6a, 6b, 6c, . . . ) and temporal synchronisation of the aperture segments (6a, 6b, 6c, . . . ). The necessary mounting of additional transmission pinions (4) in the housing (11, 12) mechanically stabilises the entire system, as forces can be dissipated directly into the housing (11, 12). This embodiment is particularly advantageous, but at least the drive pinion (3) on the output shaft (2) of the electric drive and actuator (1) is required.

In a particularly preferred embodiment, the segmented shutter aperture (6) consists of at least three aperture segments (6a, 6b, 6c, . . . ). These are designed with a triangular base shape such that an interlocking mechanism (6z) is provided on one edge, on which the drive pinion (3) or optional transmission pinion (4) can engage. It has proven advantageous that the shape of the individual elements corresponds to that of an equilateral triangle, or at least an isosceles triangle. When using an equilateral triangle, the edges (6g) that do not have toothing (6z) are designed in such a way that a form-fitting connection to the adjacent elements can be established. When using an isosceles triangle, the sides of the triangle, which are of identical length, are in positive contact with the adjacent aperture segments (6a, 6b, 6c, . . . ). This positive connection not only ensures precise guidance of the aperture segments (6a, 6b, 6c, . . . ), but also provides a simultaneous seal, so that no material side streams can occur except those specified by the aperture opening. Another advantage of the form-fitting connection of the aperture segments (6a, 6b, 6c, . . . ) is the mechanical stiffening of the segmented shutter aperture (6) according to the invention, so that it can withstand greater loads from flowable and/or free-flowing material.

Another embodiment provides for the housing (11, 12) to be designed in multiple parts. It has proven particularly advantageous to design the housing (11, 12) in two parts. A first housing part (11) primarily serves to support the transmission unit described above and to accommodate and support the ring gear (5) described above and the aperture segments (6a, 6b, 6c, . . . ), whereas a second housing part (12) seals these units and also performs support functions. The first housing part (11) preferably consists of a flat front side, arranged at a certain distance from the electric drive and actuator motor, and a rim that completely encloses the front surface. The front side has at least two openings. The drive shaft of the motor is guided through the first opening. The drive and actuator motor (1) is located outside the housing (11, 12), whereas the drive pinion (3) located on the drive shaft is located inside the housing (11, 12). The material flow is guided through the second opening (16), which is located centrally on the first housing part (11). Additional, optionally reversible inspection openings may also be provided. The optional ring gear (5) with internal teeth is mounted in the rim. The flat part of the first housing part (11) has bearing points for the bearings (8) of additional optional transmission pinions (4). It also has guide grooves (10) for guide pins (7), which will be discussed later. Additional functional parts may also be arranged there.

The second housing part (12) also has an opening in the centre (16) through which the material flow is guided when it enters the dosing orifice from the container bottom. Furthermore, bearing points (8) for counterbearing the transmission pinions (4) or the drive pinion (3) are also possible here. The main task of the second housing part (12) is to seal the housing (11, 12) from the outside. The housing parts (11, 12) are connected to each other. Detachable connections are particularly suitable here, which means that additional openings, for example for screw connections with the first housing part, and the necessary connecting elements (18) must be provided.

It has proven advantageous to provide the aperture segments (6a, 6b, 6c, . . . ) mounted in the first housing part (11) with a guide pin (7). The aperture segments (6a, 6b, 6c, . . . ) lie in the first housing part (11) parallel to the front side of the housing (11, 12). For assembly purposes and to prevent the elements from tilting or jamming, each aperture segment (6a, 6b, 6c, . . . ) preferably has two guide pins (7) which protrude from the plane of the aperture segments (6a, 6b, 6c, . . . ) and are guided in the guide grooves (10) located on the inner front side of the first housing part (11) and the second housing part (12). Guiding the guide pin (7) in the second housing part (12) is also necessary to prevent the elements from tilting.

The special design and the n aperture segments (6a, 6b, 6c, . . . ) sliding over each other create an n-sided opening whose geometric centre lies on the axis of the material flow. The opening always has exactly as many corners as there are aperture segments (6a, 6b, 6c, . . . ) installed. A corner is formed by the form-fitting sliding of one edge of two adjacent aperture segments (6a, 6b, 6c, . . . ) against each other, creating a corner. The material can thus be removed from a container completely without the risk of material jamming.

Another advantage of the segmented shutter aperture (6) according to the invention is that only the individual aperture segments (6a, 6b, 6c, . . . ) are moved via drive pinion (3), transmission pinion (4) and surrounding ring gear (5), while all other elements of the dosing orifice according to the invention remain rigid, rigid in particular with respect to the container.

In the embodiment described above, which has proven to be particularly advantageous, the drive pinion (3) is excited with a rotary movement from the drive and actuator motor (1). The drive pinion (3) is engaged both with the toothing (6z) on one side of an aperture segment (6a, 6b, 6c, . . . ) and with the ring gear (5) with internal teeth, which has proven to be particularly advantageous. The direction of rotation of the drive pinion (3) and the surrounding ring gear (5) are necessarily and naturally opposite. The rotary movement of the drive pinion (3) is converted into a translational movement of the aperture segment (6a, 6b, 6c, . . . ) by the toothing (6z) on the aperture segment (6a, 6b, 6c, . . . ) and the engagement of the drive pinion (3) therein.

Additional transmission pinions (4) that are possible and considered particularly advantageous are engaged with the surrounding ring gear (5) with internal teeth and are thus driven synchronously with the drive pinion (3) and transmit this rotary motion, just like the drive pinion (3), into a translational motion to additional aperture segments (6a, 6b, 6c, . . . ).

A number of six aperture segments (6a, 6b, 6c, 6d, 6e, 6f) has proven to be particularly advantageous. The opening width of the shutter aperture (6) is controlled by translating the rotary motion of the drive pinion (3) and the optional additional transmission pinions (4) into a translational motion, which causes the aperture segments (6a, 6b, 6c, 6d, 6e, 6f) to slide against each other.

In a special embodiment, the housing (11, 12) is designed to be pressure-tight. This protects the internal transmission unit and the mechanics of the segmented shutter aperture (6) against external influences. Likewise, the detachable connection between the two housing parts (11, 12) is designed in such away that, in the event of a mechanical problem inside the housing (11, 12), it can be opened and repaired within a short time. A sealing ring (13) located between the first housing part (11) and the second housing part (12) additionally ensures the required pressure and dust tightness.

It has also proven to be particularly advantageous that at least one element of the segmented shutter aperture (6) is grounded. This prevents static charging due to friction of the material on the aperture segments (6a, 6b, 6c, . . . ), which in the worst case can lead to material jamming.

In a special embodiment, the dosing orifice is extended by an element (17) to accelerate the material flow downstream after the shutter aperture (6). This enables faster filling of the downstream mould and minimises the risk of material jamming in the shutter aperture (6). Connected via a connecting flange to the first housing part (11) or directly to the container bottom at designated mounting points, a preferably cylindrical hollow body with an inner diameter corresponding to at least the diameter of an open shutter aperture (6) is connected. In a transition area from the connecting flange to the hollow body, there is a circumferential recess (20) in the flange with a radius greater than that of the hollow cylinder, but smaller than the outer radius of the connecting flange. In a particularly preferred embodiment, the hollow cylinder is designed such that at least one, preferably several holes (21) are distributed around the circumference of the outside of the cylinder in the area of the surrounding recess in the flange area. These holes are inclined towards the axis of the hollow cylinder and thus the material flow, whereby they are arranged in the wall of the hollow cylinder at an angle of at least 1° to a maximum of 89°, preferably at an angle of 20° to 75°, particularly preferably at an angle between 30° and 50°. The circumferential recess (20) can be pressurised with compressed air via a connection (19), from where it then flows through the holes into the interior of the hollow cylinder and encounters the material flow.

It has proven to be particularly advantageous to connect an individually controllable shutter aperture, preferably a segmented shutter aperture (6) as described above, to the element (17) for accelerating the material flow at each individual container outlet in order to obtain an optimal result when filling a mould with complex geometry. In addition, energy savings are possible because each outlet can be controlled individually. It is also possible to switch off certain outlets earlier or later, which leads to energy savings in the compressed air area.

The task defined above is further solved by a container for storing and dispensing flowable and/or free-flowing material with a container base having at least two outlets, whereby the flowable and/or free-flowing material can be removed from the container through these at least two outlets. The container according to the invention is characterised in that each outlet in the container base can be controlled separately and independently via a dosing orifice as described above.

A container here refers to a vessel in which the bulk material is stored or conveyed. This includes, but is not limited to, tanks, silos and conveyor hoses that have at least one material outlet.

It has proven advantageous for the container base to have a funnel-shaped recess at each outlet, which can be retrofitted if desired.

The bottom of the container from which free-flowing material is to be removed has funnel-shaped recesses from which the material is directed to the dosing orifice. Each dosing orifice should have its own, preferably funnel-shaped recess. The novel container bottom is either provided directly during the manufacture of the container or inserted into a bottomless container as a retrofit part.

In a further development of the container, each dosing orifice described above can be individually controlled with regard to at least the control parameters of minimum opening width, maximum opening width, opening speed and closing speed.

Advantageously, the dosing orifices according to the invention are not controlled merely as binary opening or closing, but within the framework of an adaptive control system capable of learning. This enables the individual control and individual parameterisation of each individual dosing orifice according to the invention by means of at least the control parameters
a) minimum opening width,
b) maximum opening width,
c) opening speed (speed open),
d) closing speed (speed closed).

Another embodiment of the container provides that by equating the control parameters minimum opening width and maximum opening width, a static output of flowable and/or free-flowing material without pulsation of the output can be achieved.

It has proven advantageous if the container according to the invention further comprises
a device for real-time flow monitoring, which is arranged downstream of each dosing orifice according to the invention,
a device for automatically shutting down each dosing orifice according to the invention when a material flow stop is detected,
   wherein the control parameters of each dosing orifice as described above can be automatically adjusted depending on real-time flow data and/or mould geometry and/or an assignment to specific filling ranges.

These advantageous further developments allow both pulsating movement profiles and static fixed values to be implemented for each individual dosing orifice according to the invention. This means that the minimum and maximum opening widths can be selected identically in order to achieve static operation. This high control resolution allows targeted adaptation to different mould filling scenarios and ensures that each dosing orifice according to the invention is controlled and operated exactly as required.

The present invention thus provides, for the first time, an adaptive system that directly affects the process quality, material distribution and energy efficiency of filling processes. The adaptive system according to the invention exceeds the capabilities of conventional dosing systems, in which influence can only be exerted via the design of the dosing disc and its manual timing.

In a further aspect, the present invention relates to a device for dosing flowable or free-flowing material, comprising
a container according to the invention, as described above,
a dosing orifice according to the invention, as described above, for each outlet of the container according to the invention, as described above.

Further objectives, features, advantages and possible applications are apparent from the following description of embodiments of the invention, which are not limiting, with reference to the figures. All features described and/or illustrated, either individually or in any combination, form the subject matter of the invention, even independently of their summary in the claims or their reference back. A particularly preferred embodiment is shown.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 a perspective view of the dosing element with drive motor, in the assembled state,

FIG. 2 a schematic exploded view of the dosing orifice in perspective,

FIG. 3 a baffle element,

FIG. 4 an element 17 for accelerating the material flow,

FIG. 5 a first housing part,

FIG. 6 a second housing part,

FIG. 7 a schematic view of a dosing orifice according to the invention in a first opening position,

FIG. 8 a schematic view of a dosing orifice according to the invention in a second opening position,

FIG. 9 a schematic view of a dosing orifice according to the invention in a third opening position,

FIG. 10 a schematic view of a container base according to the invention from below with dosing orifices according to the invention, and

FIG. 11 a schematic view of a container base according to the invention from above with dosing orifices according to the invention.

In the figures, all identical components are designated with the same reference symbols; however, for reasons of clarity, not all reference symbols are included in all illustrations.

### DETAILED DESCRIPTION OF THE INVENTION

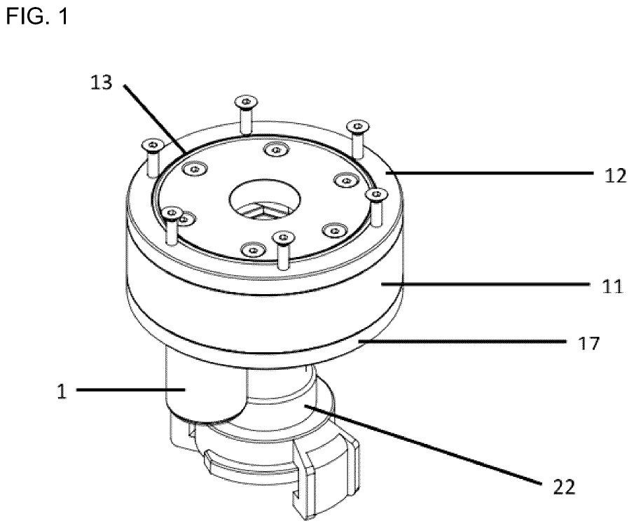

FIG. 1 shows a schematic drawing of the dosing orifice in perspective view. The illustration corresponds to the flow direction through the dosing orifice. Arranged in the flow direction are the second housing part 12, the first housing part 11, the element 17 for accelerating the material flow, and the drive and actuator motor 1.

On the container side, a sealing ring 13 is located in a groove in the second housing part 12 to provide a dust- and pressure-tight connection to the container. The unit can be attached to a mould to be filled using a connection connector 22.

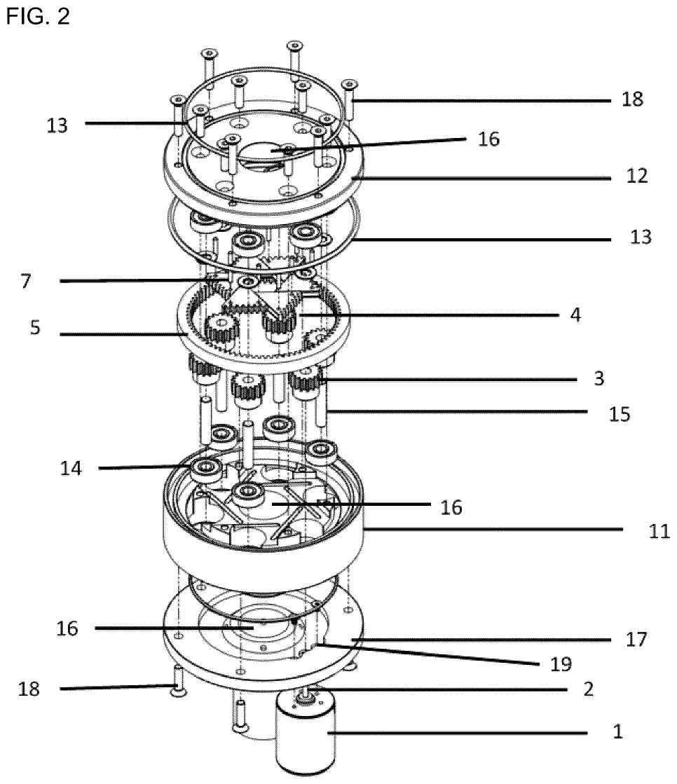

FIG. 2 shows details of the design. The central unit of the dosing orifice, the aperture mechanism, is formed by the ring gear 5, drive pinion 3 and transmission pinion 4, several aperture segments 6a, 6b, 6c, . . . and guide pins 7.

The ring gear 5 is mounted in the first housing part 11. Corresponding recesses are provided in the first housing part 11 and in the second housing part 12 to accommodate the bearings 14 for the shafts 15 of the drive pinion 3 and the transmission pinions 4. Due to the perspective view, the recesses are only visible in the second housing part. The drive pinion 3 and the transmission pinions 4 are guided inside the ring gear 5.

A central opening 16 for the material flow is provided in the first housing part 11, in the second housing part 12 and in the element 17 for accelerating the material flow. Furthermore, guide grooves 10 are milled in the number of the screen elements to accommodate guide pins 7 of the screen elements. These are guided through provided bores in the aperture segment 6a, 6b, 6c, . . . .

The aperture segments 6a, 6b, 6c, . . . have a triangular basic shape, with two edges 6g each in contact with an adjacent aperture segment 6a, 6b, 6c, . . . and the third edge 6z provided with toothing and in contact with the drive pinion 3 or one of the transmission pinions 4.

The drive pinion 3 is connected to the drive and actuator motor 1 via a shaft.

Both housing halves are fastened to each other by means of a screw connection 18. A sealing ring 13 is located between the two housing halves 11, 12 to seal against dust and moisture and to ensure pressure tightness.

Element 17 is screwed onto the first housing part 11 to accelerate the material flow. It also has a central opening 16 for the material flow and allows the drive shaft 2 from the drive and actuator motor 1 to pass through to the drive pinion 3. A connection 19 for the supply of compressed air is also provided.

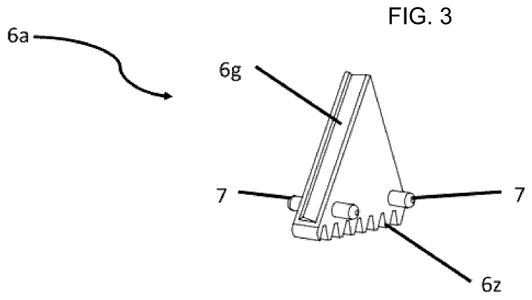

FIG. 3 shows, as an example for an aperture segment 6a, 6b, 6c, 6d, 6e, 6f. It is clearly visible that the edge 6g, on which another aperture element slides during the opening or closing process of the aperture, is shaped in such a way that a form-fitting, material-tight connection to the adjacent aperture element is possible. The toothing 6z is designed to fit the drive pinion 3 or the transmission pinions 4.

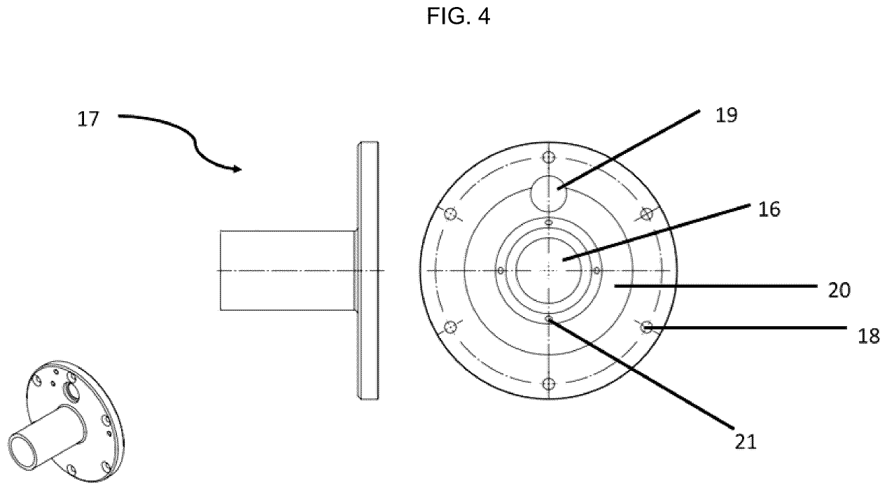

FIG. 4 shows the element 17 for accelerating the material flow. The opening 16 for the material flow is rotationally symmetrical in the centre of the element and allows the material to pass through. With a circumferential flange and the existing fastening options, the element 17 for accelerating the material flow is screwed to the first housing part 11. A circumferential recess 20, into which compressed air 19 is blown, has rotationally symmetrical, obliquely arranged holes 21 leading in the direction of the material flow, through which the compressed air is directed onto the material flow.

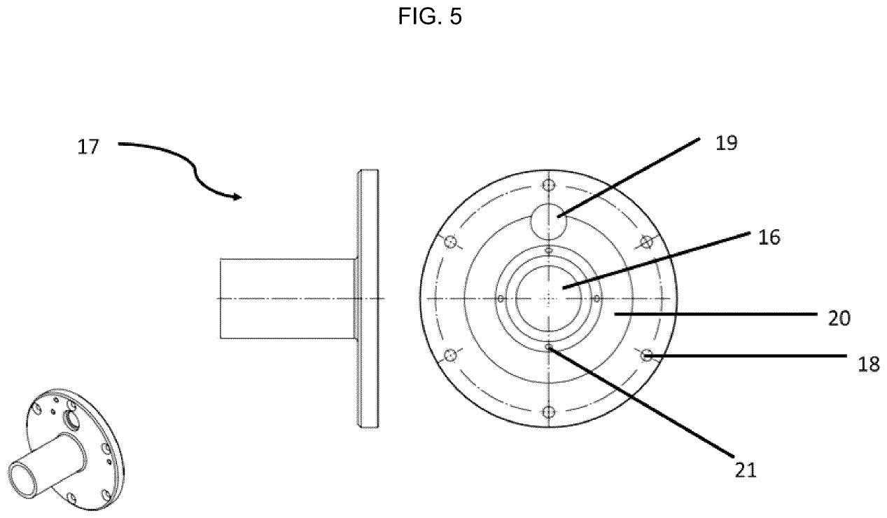

FIG. 5 shows the first housing part 11 with all bearing points 8 for accommodating the bearings 14 for the drive pinion 3 and the transmission pinions 4. The guide grooves 10 in which the guide pins 7 of the aperture segments 6a, 6b, 6c, 6d, 6e, 6f are guided are also visible.

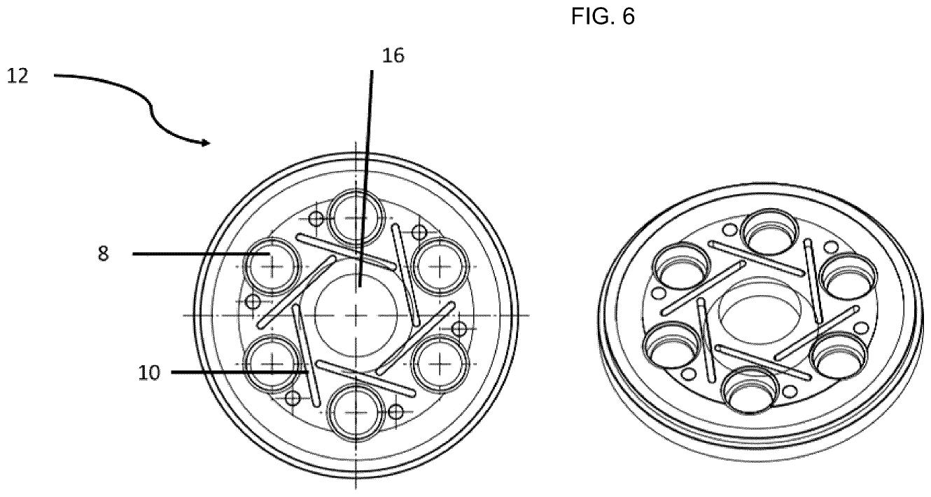

FIG. 6 shows the second housing part 12 with all bearing points 8 for accommodating the bearings 14 for the drive pinion 3 and the transmission pinions 4. The guide grooves 10 in which the guide pins 7 of the aperture segments 6a, 6b, 6c, 6d, 6e, 6f are guided are also visible.

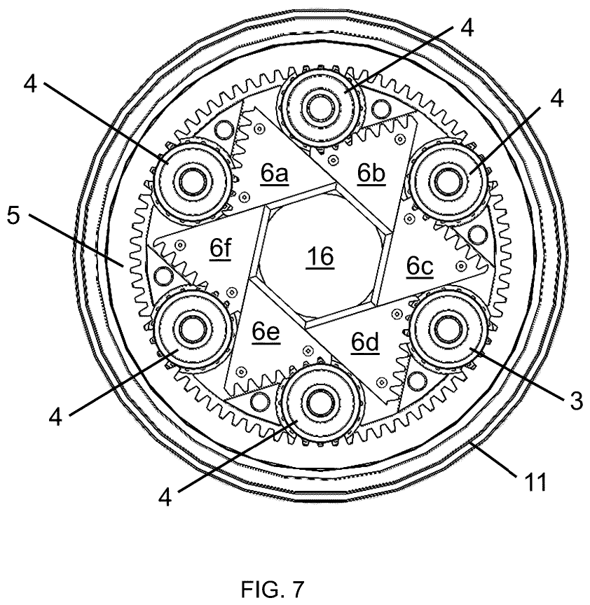

FIGS. 7, 8 and 9 show examples of three opening positions of a dosing orifice according to the invention. In these views, individual elements have not been shown in order to more clearly illustrate the interaction of the aperture segments 6a, 6b, 6c, 6d, 6e, 6f with each other and with the drive pinion 3 and the transmission pinions 4.

The illustrations show how the aperture segments 6a, 6b, 6c, 6d, 6e, 6f are operatively connected to each other with their isosceles sides via a form-fitting connection, here in a kind of tongue-and-groove system, with their sides 6g. Each of the aperture segments 6a, 6b, 6c, 6d, 6e, 6f slides on the adjacent aperture segments 6a, 6b, 6c, 6d, 6e, 6f when driven by a pinion 3, 4, thus ensuring uniform movement.

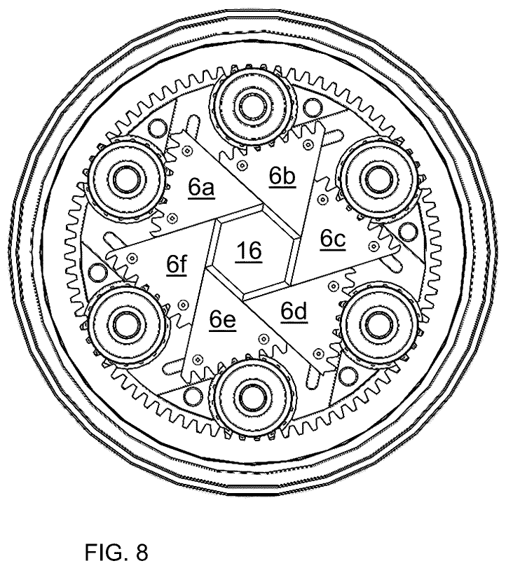

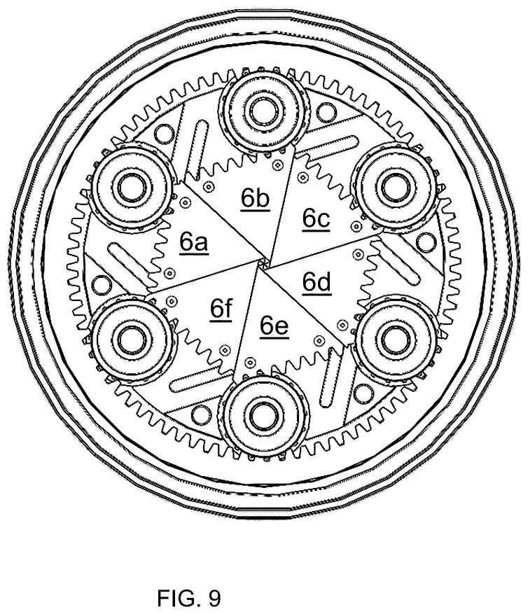

FIG. 7 shows the largest possible opening 16 for a material flow, with the aperture segments 6a, 6b, 6c, 6d, 6e, 6f deflected to their maximum extent. The FIG. 8 shows an approximately medium-sized opening 16, with the aperture segments 6a, 6b, 6c, 6d, 6e, 6f in the middle position. The engagement of the pinions 3, 4 in the toothing 6z on the respective aperture segments 6a, 6b, 6c, 6d, 6e, 6f can be clearly seen here. FIG. 9 shows an essentially completely closed opening 16, in which the aperture segments 6a, 6b, 6c, 6d, 6e, 6f are bent to their maximum extent.

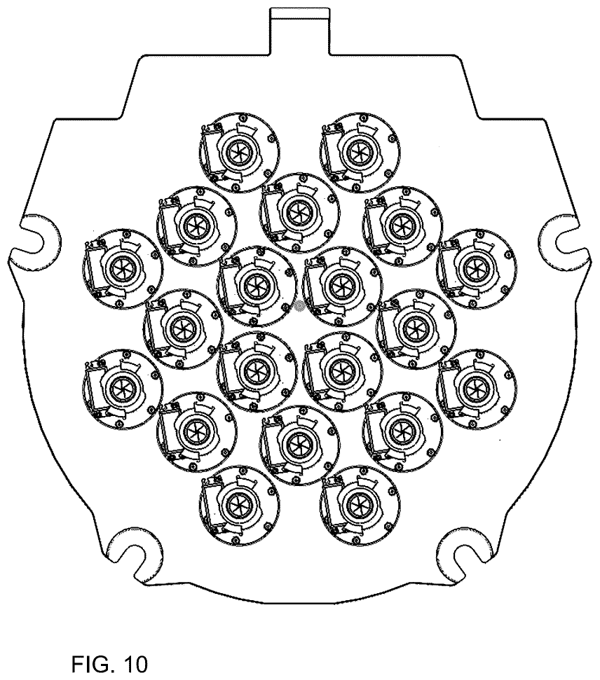

FIG. 10 shows an example of the bottom of a container according to the invention with a plurality of outlets therein, with a dosing orifice according to the invention attached to each outlet. Since each of these dosing orifices according to the invention can be controlled individually, it is possible to dispense the flowable and/or free-flowing material in different quantities and at different gradients across the surface.

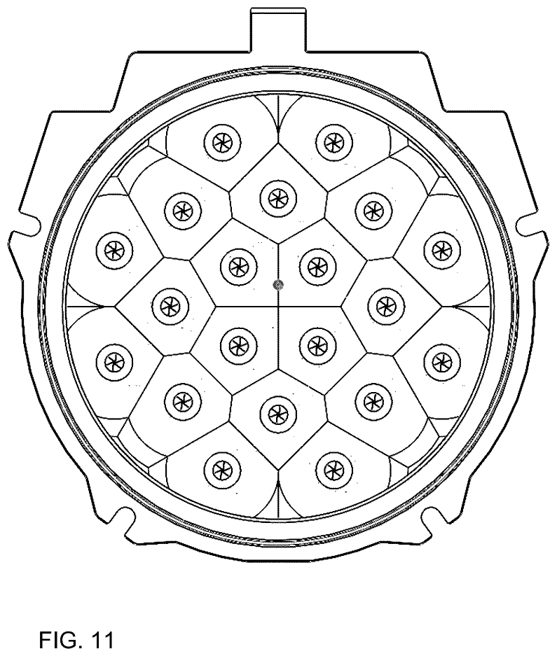

Finally, FIG. 11 shows the bottom of a container according to the invention shown in FIG. 10 with a plurality of outlets therein. Here, the dosing orifices of the invention located below can be seen through the outlets, of which only the aperture segments 6a, 6b, 6c, 6d, 6e, 6f can be seen in the closed state in this illustration.

### REFERENCE

1 drive and actuator motor
2 output shaft
3 drive pinion
4 transmission pinion
5 ring gear
6 shutter aperture
6a, 6b, 6c, . . . aperture segments
6z toothing on aperture segment
6g front side of aperture segment
7 guide pin
8 bearing points in housing
10 guide groove
11 first housing part
12 second housing part 2
13 sealing ring
14 bearing
15 shaft for pinion
16 opening for material flow
17 element for accelerating the material flow
18 screw connections
19 compressed air connection
20 recess for compressed air
21 bore for compressed air
22 possible connection to a mould

1. A dosing orifice with variable opening width for dosing flowable and/or free-flowing material, comprising
an opening (16) for the flowable and/or free-flowing material, wherein the opening (16) is designed for connection to an outlet of a container,
a shutter aperture (6) for opening and closing the opening (16) for the flowable and/or free-flowing material,
an electric drive and actuator motor (1) for the shutter aperture (6),
wherein the geometric centre of the shutter aperture (6) lies on the axis of the opening (16) for the flowable and/or free-flowing material.

2. The dosing orifice unit according to claim 1, wherein the shutter aperture (6) is a segmented shutter aperture (6), further comprising
a transmission unit (3, 4, 5) which is mechanically connected to the segmented shutter aperture (6) and the electric drive and actuator motor (1),
a housing (11, 12).

3. The dosing orifice according to claim 1, wherein
the electric drive and actuator motor (1) is designed to set its output shaft (2) in rotary motion and to output two directions of rotation, wherein at least one drive pinion (3) is attached to the output shaft (2),
and/or
the transmission unit has at least one drive pinion (3) arranged on the output shaft (2) of the electric drive and actuator motor (1) and, optionally, further transmission pinions (4) and, optionally, a ring gear (5) with internal teeth, which are mounted in the housing (11, 12).

4. The dosing orifice according to claim 1, wherein
the segmented shutter aperture (6) consists of at least three individual aperture segments (6a, 6b, 6c, . . . ), which have at least an isosceles triangular basic shape and the isosceles sides of the aperture segments (6a, 6b, 6c, . . . ) are in positive engagement (6g) with the adjacent aperture segments (6a, 6b, 6c, . . . ) and the remaining edge, at least on the aperture segment (6a, 6b, 6c, . . . ) in contact with the drive pinion (3), has a corresponding toothing (6z) for contact with the pinion (3, 4), and/or
at least the shutter aperture (6) is earthed.

5. The dosing orifice according to claim 1, wherein
the housing (11, 12) is designed in at least two parts and allows the output shaft (2) of the drive and actuator motor (1) to pass through the first housing part (11) and is designed in such a way that it allows a material flow through the segmented shutter aperture (6) with variable opening width,
and/or
the housing (11, 12) is designed to be pressure-tight and dust-tight.

6. The dosing orifice according to claim 1, wherein each of the aperture segments (6a, 6b, 6c, . . . ) accommodates at least one guide pin (7) which is guided in at least one housing part in a provided guide groove (10) and protrudes perpendicularly from the main surfaces of the aperture segments (6a, 6b, 6c, . . . ).

7. The dosing orifice according to one of claim 1, wherein the individual aperture segments (6a, 6b, 6c, . . . ) are arranged symmetrically in the aperture surface, wherein the aperture surface creates an opening surface with n corners, wherein n represents the number of aperture segments (6a, 6b, 6c, . . . ).

8. The dosing orifice according to claim 1, wherein the rotational movement of the output shaft (2) can be transmitted via the drive pinion (3) to the optionally surrounding ring gear (5) and thus to optionally further transmission pinions (4) and can be converted into a translational movement at least by the aperture segments (6a, 6b, 6c, . . . ) in contact with the drive pinion (3) can be converted into a translatory movement, whereby the opening width can be changed by the sliding of the aperture segments (6a, 6b, 6c, . . . ) on the contact surfaces between the individual aperture segments (6a, 6b, 6c, . . . ).

9. The dosing orifice according to claim 1, further comprising an element (17) for accelerating the material flow downstream of the shutter aperture (6), having
a preferably cylindrical hollow body,
receiving points for connection to the housing (11, 12) of the dosing orifice nit or a container base,
at least one bore (21) at an angle to the axis of the material flow, wherein this is arranged at an angle of at least 1° to a maximum of 89°, preferably at an angle of 20° to 75°, particularly preferably at an angle of between 30° and 50° in the wall of the hollow cylinder, wherein compressed air can be blown through the at least one bore onto the material flow.

10. A container for storing and dispensing flowable and/or free-flowing material with a container base having at least two outlets, wherein the flowable and/or free-flowing material can be removed from the container through these at least two outlets, characterised in that each outlet in the container base can be controlled separately and independently via a dosing orifice according to claim 1.

11. The container according to claim 10, wherein the container base has a funnel-shaped recess at each outlet and this can optionally be retrofitted.

12. The container according to claim 10, wherein each dosing orifice according to claim 1 is individually controllable with respect to at least the control parameters minimum opening width, maximum opening width, opening speed and closing speed.

13. The container according to claim 19, wherein a static dispensing of flowable and/or free-flowing material can be realised without pulsation of the dispensing by equating the control parameters minimum opening width and maximum opening width.

14. The container according to claim 10, further comprising
a device for real-time flow monitoring arranged downstream of each dosing orifice according to claim 1,
a device for automatically switching off each dosing orifice according to claim 1 upon detection of a material flow stop,
wherein the control parameters of each dosing orifice according to claim 1 are automatically adaptable in dependence on real-time flow data and/or mould geometry and/or an assignment to specific filling areas.

15. A device for dosing flowable or free-flowing material comprising
a container according to claim 10,
a dosing orifice according to claim 1 per outlet of the container according to claim 10.
